(19) United States
(12) Patent Application Publication
(10) Pub. No.: US 2025/0078016 A1
(43) Pub. Date: Mar. 6, 2025

(54) CARGO CARRIER SERVICING PLATFORM

(71) Applicant: PLM Fleet LLC, Newark, NJ (US)

(72) Inventors: Keith Shipp, Haverford, PA (US); Murli Ram, Leander, TX (US)

(21) Appl. No.: 18/754,665

(22) Filed: Jun. 26, 2024

Related U.S. Application Data
(60) Provisional application No. 63/535,034, filed on Aug. 28, 2023.

(51) Int. Cl. G06Q 10/0833; G06K 19/06; H04W 64/00

(52) U.S. Cl. CPC G06Q 10/0833; G06K 19/06037; H04W 64/003

(57) ABSTRACT

A trailer servicing system includes a central system and scannable codes. The central system includes processor(s), and at least one memory storing instructions, and an electronic storage configured to store servicing information relating to trailers. The scannable codes correspond to the trailers, and each scannable code is located on or in a respective trailer. Each scannable code is configured to, when scanned by a mobile device, enable the mobile device to communicate with the central system regarding servicing for the respective trailer. The instructions, when executed by the processor(s), cause the central system at least to perform: receiving communications, from mobile devices, resulting from scanning at least some of the scannable codes; for each of the communications: accessing servicing information relating to a corresponding trailer that corresponds to the respective scannable code that was scanned; and transmitting, to the respective mobile device, servicing information relating to the corresponding trailer.

### CROSS-REFERENCE TO RELATED APPLICATIONS

The present application claims the benefit of and priority to U.S. Provisional Application No. 63/535,034, filed Aug. 28, 2023, which is hereby incorporated by reference herein in its entirety.

### TECHNICAL FIELD

The present disclosure relates to cargo carriers, and more particularly, to a servicing platform for cargo carriers.

### BACKGROUND

Cargo carriers, such as trailers, provide the backbone of economies, transporting everything from food to automobiles. Goods are loaded into the cargo carriers, and trucks or tractors (e.g., semis) move the cargo carriers to transport the goods therein. Economies do not operate at full potential if cargo carriers experience long down times. Accordingly, there is interest in reducing the down time of cargo carriers.

### SUMMARY

The present disclosure relates to an electronic trailer servicing platform for facilitating servicing of cargo carriers, such as a fleet of trailers.

In accordance with aspects of the present disclosure, a trailer servicing system for facilitating servicing of a trailer fleet includes: a central system and a plurality of scannable codes. The central system includes: an electronic storage configured to store servicing information relating a plurality of trailers, at least one processor, and at least one memory storing instructions. The plurality of scannable codes corresponds to the plurality of trailers, and each scannable code of the plurality of scannable codes is located on or in a respective trailer of the plurality of trailer. Each scannable code is configured to, when scanned by a mobile device, enable the mobile device to communicate with the central system regarding servicing for the respective trailer. The instructions, when executed by the at least one processor of the central system, cause the central system at least to perform: receiving a plurality of communications, from a plurality of mobile devices, resulting from scanning at least some of the plurality of scannable codes; and for each of the plurality of communications: accessing, in the electronic storage, servicing information relating to a corresponding trailer, of the plurality of trailers, that corresponds to the respective scannable code that was scanned; and transmitting, to the respective mobile device, at least a portion of the servicing information relating to the corresponding trailer.

In various embodiments of the trailer servicing system, the plurality of scannable codes includes QR codes.

In various embodiments of the trailer servicing system, the servicing information relating to the corresponding trailer includes an identifier of the corresponding trailer.

In various embodiments of the trailer servicing system, the servicing information relating to the corresponding trailer is provided in HTML code relating to the corresponding trailer.

In various embodiments of the trailer servicing system, the HTML code, when executed, causes display of a selectable first user interface element for requesting service for the corresponding trailer.

In various embodiments of the trailer servicing system, the HTML code, when executed, causes display of a selectable second user interface element for a technician relating to servicing work orders.

In various embodiments of the trailer servicing system, the instructions, when executed by the at least one processor of the central system, further cause the central system at least to perform: based on selection of the first user interface element, transmitting, to the respective mobile device, further HTML code relating to at least one of: creating a service request, or viewing an existing service request; and based on selection of the second user interface element, transmitting, to the respective mobile device, further HTML code relating to at least one of: requesting authorization for a work order, or reviewing an open work order.

In accordance with aspects of the present disclosure, a processor-implemented method in a central system is disclosed for facilitating servicing of a trailer fleet. The method includes: receiving a plurality of communications, from a plurality of mobile devices, resulting from scanning at least some of a plurality of scannable codes, the plurality of scannable codes corresponding to a plurality of trailers, where each scannable code of the plurality of scannable codes is located on or in a respective trailer of the plurality of trailer, and where each scannable code is configured to, when scanned by a mobile device, enable the mobile device to communicate with the central system regarding servicing for the respective trailer. The method further includes, for each of the plurality of communications: accessing servicing information relating to a corresponding trailer, of the plurality of trailers, that corresponds to the respective scannable code that was scanned; and transmitting, to the respective mobile device, at least a portion of the servicing information relating to the corresponding trailer.

In various embodiments of the processor-implemented method, the plurality of scannable codes includes QR code.

In various embodiments of the processor-implemented method, the servicing information relating to the corresponding trailer includes an identifier of the corresponding trailer.

In various embodiments of the processor-implemented method, the servicing information relating to the corresponding trailer is provided in HTML code relating to the corresponding trailer.

In various embodiments of the processor-implemented method, the HTML code, when executed, causes display of a selectable first user interface element for requesting service for the corresponding trailer.

In various embodiments of the processor-implemented method, the HTML code, when executed, causes display of a selectable second user interface element for a technician relating to servicing work orders.

In various embodiments of the processor-implemented method, the processor-implemented method further includes: based on selection of the first user interface element, transmitting, to the respective mobile device, further HTML code relating to at least one of: creating a service request, or viewing an existing service request; and based on selection of the second user interface element, transmitting, to the respective mobile device, further HTML code relating to at least one of: requesting authorization for a work order, or reviewing an open work order.

In accordance with aspects of the present disclosure, a non-transitory processor-readable medium stores instructions which, when executed by at least one processor of a central system, cause the central system at least to perform: receiving a plurality of communications, from a plurality of mobile devices, resulting from scanning at least some of a plurality of scannable codes, the plurality of scannable codes corresponding to a plurality of trailers, where each scannable code of the plurality of scannable codes is located on or in a respective trailer of the plurality of trailer, and where each scannable code is configured to, when scanned by a mobile device, enable the mobile device to communicate with the central system regarding servicing for the respective trailer; and for each of the plurality of communications: accessing servicing information relating to a corresponding trailer, of the plurality of trailers, that corresponds to the respective scannable code that was scanned; and transmitting, to the respective mobile device, at least a portion of the servicing information relating to the corresponding trailer.

In various embodiments of the processor-readable medium, the plurality of scannable codes includes QR codes.

In various embodiments of the processor-readable medium, the servicing information relating to the corresponding trailer includes an identifier of the corresponding trailer.

In various embodiments of the processor-readable medium, the servicing information relating to the corresponding trailer is provided in HTML code relating to the corresponding trailer.

In various embodiments of the processor-readable medium, the HTML code, when executed, causes display of at least one of the following: a selectable first user interface element for requesting service for the corresponding trailer, or a selectable second user interface element for a technician relating to servicing work orders.

In various embodiments of the processor-readable medium, the processor-readable medium further includes: based on selection of the first user interface element, transmitting, to the respective mobile device, further HTML code relating to at least one of: creating a service request, or viewing an existing service request; and based on selection of the second user interface element, transmitting, to the respective mobile device, further HTML code relating to at least one of: requesting authorization for a work order, or reviewing an open work order.

The details of one or more embodiments of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

A detailed description of embodiments of the disclosure will be made with reference to the accompanying drawings, wherein like numerals designate corresponding parts in the figures:

FIG. 1 is a diagram of an example cargo carrier and scannable code, in accordance with aspects of the present disclosure;

FIG. 2 is a diagram of an example scannable code, in accordance with aspects of the present disclosure;

FIG. 3 is a diagram of an example of interactions with a scannable code and a central system, in accordance with aspects of the present disclosure;

FIG. 4 is a diagram of an example of components of a central system, in accordance with aspects of the present disclosure;

FIG. 5 is a diagram of an example of servicing information for a cargo carrier, in accordance with aspects of the present disclosure;

FIG. 6 is a diagram of an example of central system operations, in accordance with aspects of the present disclosure;

FIG. 7 is a diagram of an example of a display resulting from scanning a scannable code, in accordance with aspects of the present disclosure;

FIG. 8 is a diagram of an example a display relating to service requests, in accordance with aspects of the present disclosure;

FIG. 9 is a diagram of an example a display relating to work orders for a technician, in accordance with aspects of the present disclosure;

FIG. 10 is a diagram of an example of a display screen for reviewing a work order, in accordance with aspects of the present disclosure;

FIG. 11 is a diagram of an example of a display screen for listing work orders, in accordance with aspects of the present disclosure; and

FIG. 12 is a diagram of an example of a display screen for a dashboard, in accordance with aspects of the present disclosure.

### DETAILED DESCRIPTION

The present disclosure relates to an electronic platform for facilitating servicing of cargo carriers, such as a fleet of trailers.

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

Cargo carriers travel on roadways across different geographies and time periods. When cargo carriers need to be serviced, the need may arise at unexpected locations and times. The service may involve, for example, repairing or changing a flat tire, changing a broken light, or repairing a side panel, among other possibilities. Facilitating servicing of cargo carriers reduces down time and, thereby, improves utilization. As described in more detail below, aspects of the present disclosure provide an electronic platform that facilitates servicing of cargo carriers such as trailers.

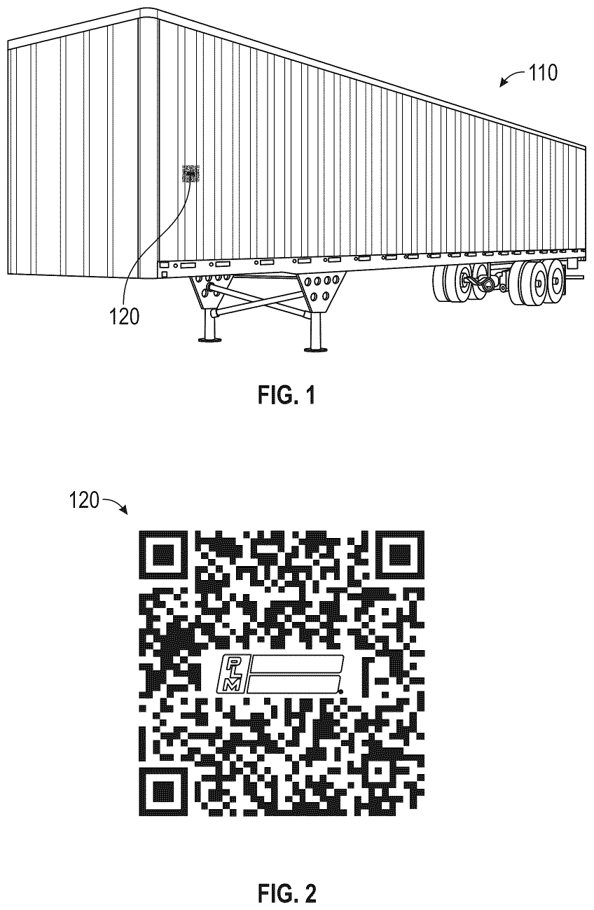

Referring to FIG. 1, there is shown a diagram of an example of a cargo carrier, e.g., a trailer 110. As used herein, a “cargo carrier” refers to and includes any type of container or holder that is configured to carry items for and in transport. A trailer is one type of cargo carrier. The present application uses trailers as an example of cargo carriers and may refer to trailers throughout the examples. However, it is intended that any description that refers to a trailer shall be treated as though the description referred to a cargo carrier, as well.

In accordance with aspects of the present disclosure, a scannable code 120 is associated with the trailer 110 and can be located on or in the trailer 110. In various embodiments, the scannable code 120 may be a weatherproof decal that is affixed to a side of the trailer 110, as shown in FIG. 1. In various embodiments, the scannable code 120 may be secured to any location of the trailer 110 and may be secured in any manner, such as, without limitation, by an adhesive and/or by screws or bolts, or by any other manner. FIG. 1 shows one cargo carrier simply as an example. The present disclosure contemplates that scannable codes may be provided for a fleet of cargo carriers.

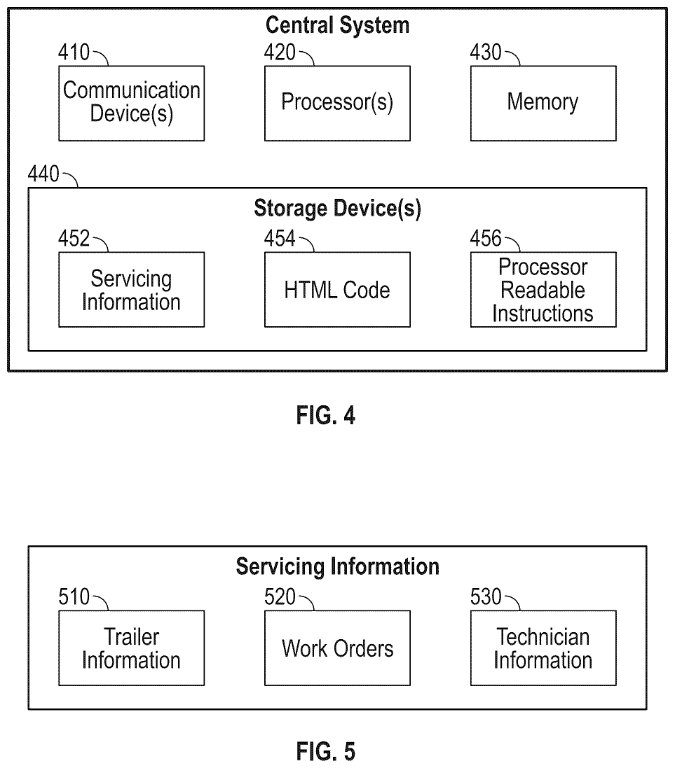

FIG. 2 shows an example of the scannable code 120 of FIG. 1. As shown in FIG. 2, the scannable code 120 is a quick response (QR) code. In various embodiments, the scannable code may be another type of code different from a QR code, such as, without limitation, a bar code. In accordance with aspects of the present disclosure, the scannable code may be configured to, when scanned by a mobile device (e.g., smartphone, tablet, etc.), enable the mobile device to communicate with a central system that facilitates servicing of a trailer, in accordance with aspects of the present disclosure. Aspects of the central system and communications with the central system are described in connection with FIGS. 4-6 below.

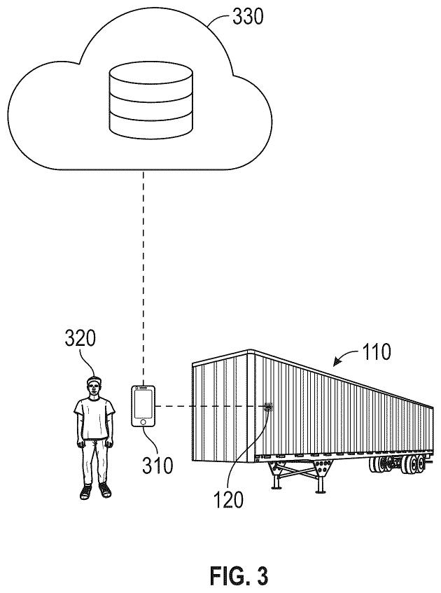

Referring now to FIG. 3, there is shown an example of interactions with a scannable code and a central system. FIG. 3 shows a trailer 110 having a scannable code 120 according to aspects of the present disclosure. As mentioned above, a person 320 may scan the scannable code 120 using a mobile device 310, such as a smartphone or a tablet or another type of mobile device that has data communication capability (e.g., cellular communication, Wi-Fi, satellite, etc.). The scannable code 120 is configured to, when scanned by the mobile device 310, enable the mobile device 310 to communicate with the central system 330.

In embodiments where the scannable code 120 is a QR code, the QR code may be scanned by a camera of the mobile device 310 and may be decoded by the mobile device 310 into a uniform resource locator (URL). Persons skilled in the art will recognize and understand such operations of mobile devices and QR codes. In accordance with aspects of the present disclosure, the QR code is decoded into a URL that identifies a webpage, served by the central system 330, that is related to servicing the trailer 110. Accordingly, when the QR code is scanned by the mobile device 310, the QR code enables a web browser of the mobile device 310 to request a webpage served by the central system 330 for servicing the trailer 110.

In various embodiments, the mobile device 310 may have an application that is specifically designed to operate with the central system 330. The application (not shown) may use a camera of the mobile device 310 to capture an image of the scannable code 120 and may decode the scannable code 120 into various information, such as, without limitation, identifying information that can be used to identify the trailer 110, among other information. Using the information, the application may engage in communications with the central system 330. In contrast to the approach described above, a web browser is not needed where a dedicated application is used.

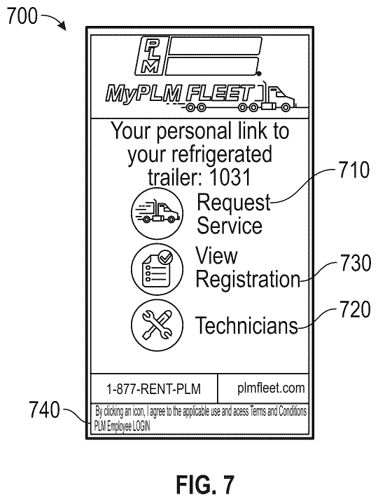

Whether a web browser or an application is used by the mobile device 310 to communicate with the central system 330, the central system 330 may facilitate servicing of the trailer 110 for the person 320. In various scenarios, the person 320 scanning the scannable code 120 may be a driver who is transporting the trailer 110 and who requests that the trailer be serviced, or the person 320 may be a technician who is responding to the service request. In other scenarios, the person 320 may be an employee of the company providing the central system 330 who is, for example, performing administrative tasks for the trailer 110. The central system 330 may facilitate the tasks of any such persons 320, as described below herein. Aspects of the central system 330 are described in connection with FIGS. 4-6 below. Various examples of the mobile device's display screens and selectable user interface elements are described in connection with FIGS. 7-9 below.

FIG. 4 shows an example of components of a central system, such as central system 330 of FIG. 3. The system is “central” in the sense the system manages information and services centrally across different geographies. The implementation of the central system, however, may be distributed geographically such that portions of computing resources may be located in different geographies. In various embodiments, the central system may be a proprietary system, a cloud system, a standalone system, a geographically distributed system, or a combination of such systems. All such embodiments are contemplated to be within the scope of the present disclosure.

The central system includes one or more communication devices 410, processors 420, memory 430, and storage devices 440. The communication device(s) 410 may include an Ethernet communication device, a Wi-Fi communication device, and/or a cellular communication device, or any other communication device. The communication device(s) 410 operate to communicate with mobile devices, such as mobile devices 310 of FIG. 3, to facilitate servicing of cargo carriers.

The processor(s) 420 may include any computing circuitry and may include, without limitation, a single-core central processing unit (CPU), a multi-core CPU, a graphics processing unit (GPU), or any other computing circuitry. The memory 430 may include random access memory (RAM) and/or non-volatile memory, among other types of memory. The storage device(s) 440 may include magnetic storage (e.g., hard disk drive), solid state storage (e.g., solid stage drives), and/or optical storage, among other types storage devices. The storage device(s) 440 may store servicing information 452, HTML code 454, and processor-readable instructions 456. The servicing information 452 includes information related to servicing of trailers and will be described in more detail in connection with FIG. 5.

The HTML code 454 includes code that the central system provides to mobile devices when the mobile devices communicate with the central system via a web browser. In accordance with aspects of the present disclosure, the HTML code 454 that the central system provides to a mobile device may include code portions that are specific to a trailer, code portions that identify the trailer, and/or code portions that present servicing information 452 specific to a trailer. Various examples of displays resulting for executing the HTML code 454 will be described in connection with FIGS. 7-9.

The processor-readable instructions 456 include instructions that implement the operations and functionality described in the present disclosure. The processor(s) 420 and memory 430 cooperate to execute the processor-readable instructions 456 to implement the various operations and functionality, such as receiving a servicing request, creating work orders, assigning a servicing request to one or more technicians, and communicating with a service requester and/or a technician, among other operations, which will be described in more detail below herein.

FIG. 4 is merely an example. Persons skilled in the art will understand that, in various embodiments, a central system may include other components not shown in FIG. 4. In various embodiments, a central system may not include every component shown in FIG. 4 (e.g., may not include HTML code in various embodiments). Such and other embodiments are contemplated to be within the scope of the present disclosure.

FIG. 5 shows an example of possible servicing information that may be stored in the central system. As shown in FIG. 5, the servicing information may include trailer information 510, work orders 520, and technician information 530. The trailer information 510 may include, for example, identifying information for trailers, specifications for the trailers, vehicle registration, trailer registration, ownership and lease information, and/or contact information for notifications (e.g., email, text, or app notifications, etc.), among other information. In various embodiments, the trailer information 510 may specify the QR code that is associated with each trailer.

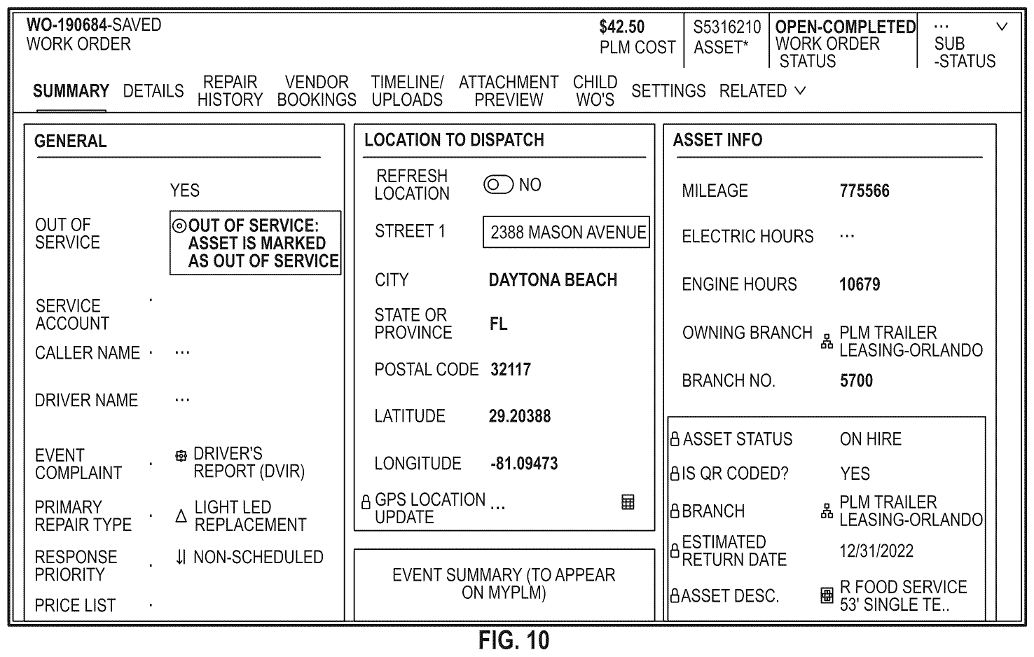

The work orders 520 may include work orders created from servicing requests. As mentioned above, work orders may involve, for example, repairing or changing a flat tire, changing a broken light, or repairing a side panel, among other possibilities. In various embodiments, the work orders 520 may include any information needed by a technician to perform the service, which may differ from one implementation to another. A more detailed description of work orders is provided below in connection with FIG. 10.

The technician information 530 may include information about technicians that are authorized to address servicing requests, including, for example, identifying information for the technicians, geographic service areas for the technicians, and availability of the technicians, among other possible information.

The servicing information may be used by processor-readable instructions (e.g., 456, FIG. 4) to facilitate servicing of trailers. FIG. 5 is merely an example. Persons skilled in the art will understand that, in various embodiments, servicing information may include other information not shown in FIG. 5. In various embodiments, servicing information may not include all of the information shown in FIG. 5. Such and other embodiments are contemplated to be within the scope of the present disclosure.

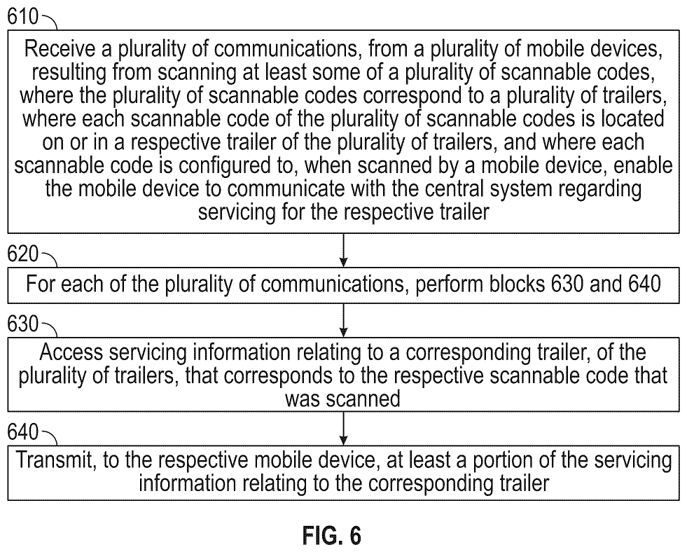

FIG. 6 is a flow diagram of an example of an operation of a central system (e.g., 330, FIG. 3). The operation may be implemented as processor-readable instructions (e.g., 456, FIG. 4) and may be executed by a processor and memory, such as by the components shown in FIG. 4.

At block 610, the operation involves receiving a plurality of communications, from a plurality of mobile devices, resulting from scanning at least some of a plurality of scannable codes, where the plurality of scannable codes correspond to a plurality of trailers, and where each scannable code of the plurality of scannable codes is located on or in a respective trailer of the plurality of trailer. Each scannable code is configured to, when scanned by a mobile device, enable the mobile device to communicate with the central system regarding servicing for the respective trailer. The scannable codes may be, for example, QR codes, as shown in FIG. 2. As mentioned above, the mobile devices may be smartphone or tablets or any device that have data communication capabilities. The person scanning the scannable code may be a service requester, a technician, or an employee of the company providing the central system, among other possibilities.

At block 620, the operation indicates that blocks 630 and 640 are performed for each of the plurality of communications that is received.

At block 630, the operation involves accessing servicing information relating to a corresponding trailer, of the plurality of trailers, that corresponds to the respective scannable code that was scanned. As mentioned above in connection with FIG. 5, the servicing information may include trailer information, work orders, and/or technician information, and may include information on associations between scannable codes (e.g., QR codes) and trailers. Accordingly, for each communication resulting from a scan of a scannable code (e.g., QR code), the operation at block 630 may identify a trailer that corresponds to the code that was scanned. The information that is accessed at block 630 may be any portion of the servicing information.

At block 640, the operation involves transmitting, to the respective mobile device, at least a portion of the servicing information relating to the corresponding trailer. In various embodiments, when the respective mobile device uses a web browser to communicate with the central system, the servicing information that is transmitted to the respective mobile device at block 640 may be provided in HTML code (e.g., 454, FIG. 4). In various embodiments, the portion of the servicing information that is transmitted at block 640 may include identifying information for the trailer that corresponds to the scannable code that was scanned. In various embodiments, other servicing information may be transmitted at block 640.

FIG. 6 is merely an example, and variations are contemplated to be within the scope of the present disclosure. In various embodiments, the operations may include blocks that are not shown in in FIG. 6. In various embodiments, the operations may not include every block shown in FIG. 6. In various embodiments, the blocks may have a different order than the order shown in FIG. 6. Such and other embodiments are contemplated to be within the scope of the present disclosure.

The following will describe various examples of display screens that may be shown. FIGS. 7-9 show examples of display screens that may be shown on a mobile device of a service requester or of a technician, among other persons. FIGS. 10-12 show examples of display screens that may be shown on a display screen of an administrator, manager, repair coordinator, customer, or other person involved in managing a cargo carrier fleet. In FIGS. 7-12, the display screens may be a screen of an application designed to communicate with the central system. In various embodiments, the display screens may be screens of a web browser that results from executing HTML code (e.g., 454, FIG. 4) provided by the central system.

FIG. 7 shows an example of a display screen that may be displayed after a mobile device (e.g., 310, FIG. 3) scans a scannable code (e.g., 120, FIG. 3). The display screen of FIG. 7 may correspond to a URL decoded from a QR code. For example, the decoded URL may have a format such as https://domain_name.net/?QRC=xxxxx, where the value of xxxxx identifies the particular QR code that is on or in the trailer. The HTML code which results in the display screen 700 is provided by the central system and may contain HTML code that specifies the QR code identifier and/or specifies a trailer identifier. For example, the QR code may be identified by the identifier value (generically shown as xxxxx), and the trailer is identified by the identifier value 1031, in the example of FIG. 7. Various links in the HTML code may refer to an aspx file with query strings that append the QR code identifier and/or the trailer identifier, such as, for example:

CheckForOpenWorkorders.aspx?ID=yyyyy&QRC=xxxxx&TNum=1031
ViewRegistration.aspx?TRAILER=1031
MenuTechnician.aspx?ID=yyyyy&QRC=xxxxx&TNum=1031

Accordingly, the HTML code that is provided by the central system may contain information that is specific to a QR code and/or specific to a trailer that corresponds to a QR code that was scanned.

The display screen may contain servicing information provided by the central system, such as an identifier of the trailer corresponding to scannable code that was scanned; i.e., “trailer: 1031” in the example of FIG. 7. In the illustrated embodiment, the central system may not know the role of the person who scanned the scannable code. For example, the central system may not know whether a service requester scanned the scannable code or whether a technician scanned the scannable code. Therefore, the display screen 700 may include a first selectable user interface element 710 for requesting service, in the case the person is a service requester, and may also include a second selectable user interface element 720 relevant to a technician, in the case the person is a technician. The display screen may also include other selectable user interface elements for other purposes, such as a selectable element 730 for viewing a registration for the cargo carrier and a selectable element 740 for an employee login for an employee of the company providing the central system, as shown in FIG. 7, among other possibilities. In various embodiments, for example, one or more interface elements (not shown) may be displayed for a service requester and/or a technician to login to the central system.

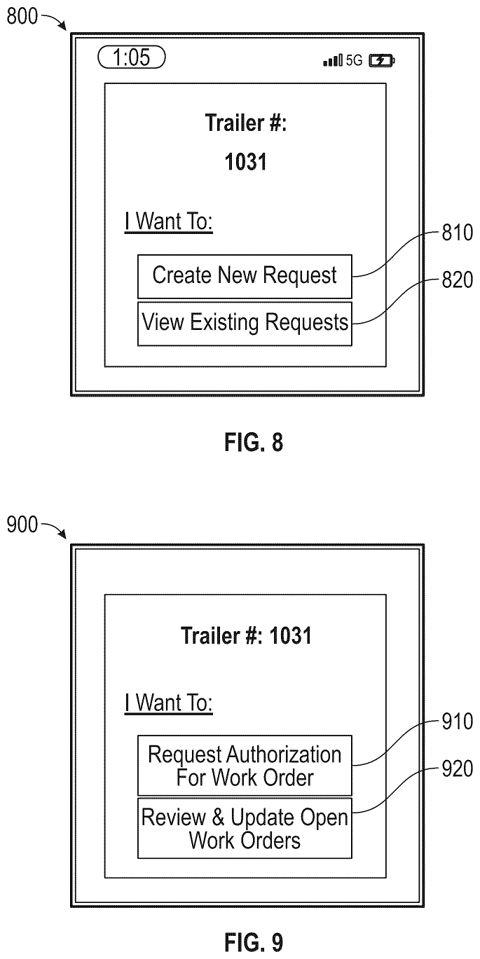

FIG. 8 shows an example of a display screen 800 that may result from a selection of the first user interface element 710 of FIG. 7 for requesting service. The display screen 800 includes a user interface element 810 for creating a new servicing request and a user interface element 820 for viewing existing servicing requests. Various potential screens may be shown after a user selects the user interface elements 810, 820. For example, based on a user selecting the user interface element 810 for creating a new servicing request, another display screen may be shown prompting the user to enter information for the new servicing request, including, for example, information such as contact details (e.g., first name, last name, email address, mobile phone number, etc.), location details (e.g., GPS location such as longitude or latitude, street address including street, city, state, and zip code, and information such as whether the trailer is on a roadside or in a yard, etc.), issue details (e.g., whether the issue is with the liftgate, tire, trailer body, or transport refrigeration unit, also known as a reefer or TRU, etc.), and/or text notes for a technician, among other possible information. The display screen may also permit a user to attach a photo or other information, such as a voice memo, among other attachments. As another example, based on a user selecting the user interface element 820 for viewing existing servicing requests, another display screen may be shown listing the existing servicing requests for the trailer. In various embodiments, each of the existing servicing requests may be expanded to show details of the servicing request and/or to revise or update the servicing request. In various embodiments, after a new service request is created for a trailer, the central system may send a notification to a party that is associated with the trailer, such as an owner or a manager of the trailer, among others. The notification can be sent by any method, such as by an email or a text, among other methods. FIG. 8 is merely an example, and other user interface elements may be displayed.

FIG. 9 shows an example of a display screen 900 that may result from a selection of the second user interface element 720 of FIG. 7 relevant to a technician. The display screen 900 includes a user interface element 910 for a technician to request authorization for a work order and a user interface element 920 for a technician to review and update open work orders. Various potential screens may be shown after a user selects the user interface elements 910, 920. For example, based on a user selecting the user interface element 910 for a technician to request authorization for a work order, another display screen may be shown prompting the technician to enter information for the authorization, including, for example, information such as contact details (e.g., first name, last name, email address, mobile phone number, etc.), location details (e.g., GPS location such as longitude or latitude, street address including street, city, state, and zip code, and information such as whether the trailer is on a roadside or in a yard, etc.), issue details (e.g., whether the issue is with the liftgate, tire, trailer body, or transport refrigeration unit, also known as a reefer or TRU, etc.), and/or text notes the technician would like to enter, among other possible information. The display screen may also permit a technician to attach a photo or other information, such as a voice memo, among other attachments. As another example, based on a user selecting the user interface element 920 for a technician to review and update open work orders, another display screen may be shown listing the open work orders for the trailer. In various embodiments, each of the open work orders may be expanded to show details of the work orders and to allow updates to the work orders, such as to indicate that a work order has been completed. In various embodiments, when a work order is updated or completed, the central system may send a notification to a party associated with a trailer, such as an owner or manager of the trailer, among others. FIG. 9 is merely an example, and other user interface elements may be displayed.

In connection with FIGS. 7-9, selection of user interface elements can be communicated to the central system, which may perform operations according to which user interface element was selected. For example, the central system may be automated to create and route work orders without human involvement. In various embodiments, the central system may assign a technician to the work order without human involvement. In various embodiments, a human operator may be involved in some aspects of the work order creation and routing and/or the technician assignment. In the case a work order is automatically routed or in the case a technician is automatically assigned without human involvement, the central system may implement configurable rules for how to perform the routing or make the assignment. For example, the routing may route a work order to a standard field operations team or may route to an emergency breakdown service. For example, the assignment may take into consideration availability of technicians who service the trailer's location, among other considerations. Also, for FIGS. 7-9, in the case a mobile device communicates with the central system using a web browser, the HTML code that is provided by the central system may contain information that is specific to a QR code and/or specific to a trailer that corresponds to a QR code, as explained above. Such HTML code is merely an example, and variations are contemplated to be within the scope of the present disclosure.

FIGS. 10-12 will now be described. As mentioned above, FIGS. 10-12 show examples of display screens that may be shown on a display screen of an administrator, manager, repair coordinator, customer, or other person involved in managing a cargo carrier fleet. In FIGS. 10-12, the display screens may be screens of an application designed to communicate with the central system or screens of a web browser that results from HTML code (e.g., 454, FIG. 4) provided by the central system.

FIG. 10 is an example of a display screen for viewing a work order. The user interface screen includes the work order number, an asset number (e.g., trailer number), a cost indicator for the servicing, and a work order status. The display screen is a screen of an example summary tab of the user interface. The user interface includes other tabs, as shown in FIG. 10. The other tabs include a details tab, a repair history tab, a vendor bookings tab, a timeline/uploads tab, an attachment preview tab (e.g., photos, audio memo, etc. attached to a service request or work order), a “child”/related work orders tab, a settings tab, and a related tab. The summary tab includes general information, such as service status for the trailer, a service account name, a caller name, a driver name, an event complaint, primary repair type, response priority, and price list. The summary tab also includes location information, such as street address, city, state, zip code, latitude, and/or longitude, and may also include options to refresh the location or obtain an updated GPS location. The summary tab also includes asset information, such as mileage of the trailer, electric hours, engine hours, owning branch, owning branch number, asset status, associated QR code, leasing branch, estimated return date, and asset description. Part of the information in FIG. 10 may be entered when a service request is created, and part of the information in FIG. 10 may be pre-stored information in the central system, such as servicing information 440 of FIG. 4. The information shown in FIG. 10 is merely an example. In various embodiments, the display screen may include other information not shown in FIG. 10. In various embodiments, the display screen may not include all of the information shown in FIG. 10. Such and other embodiments are contemplated to be within the scope of the present disclosure.

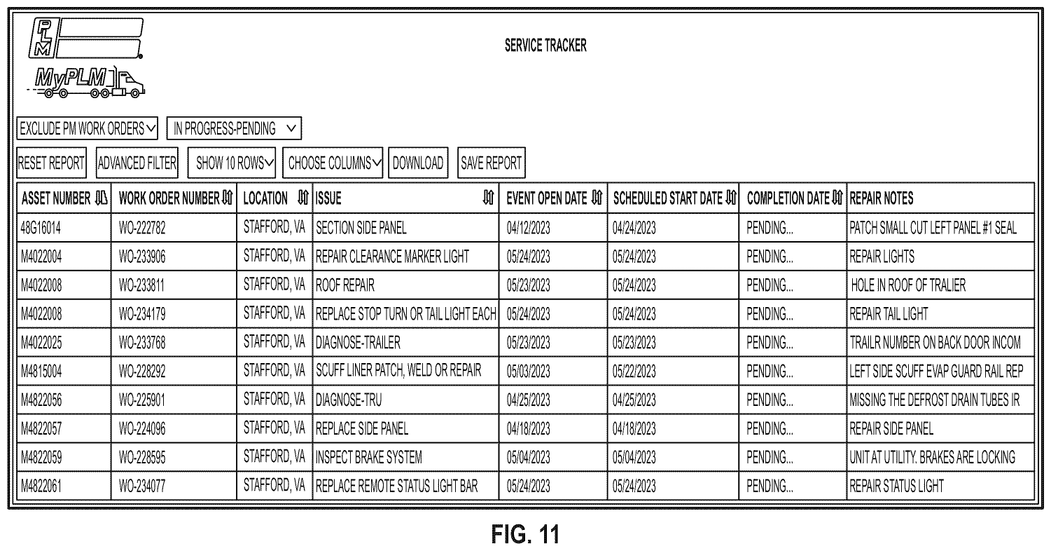

FIG. 11 is an example of a display screen for viewing work orders and related information. The display screen includes a sortable table listing work orders and information such as asset number, location, servicing issue, event open date, scheduled start date, completion date, and repair notes. The servicing issue may identify, for example, section side panel, repair clearance marker light, roof repair, replace stop turn or tail light, diagnose trailer, scuff liner patch or weld or repair, replace side panel, inspect brake system, or replace remote status light bar, among other issues. The display screen also includes selectable options for filtering the listed work orders and other selectable options, such as reset report, advanced filter, number of rows to show, columns to include or exclude from the table, download report, and save report. In various embodiments, an option in the display screen of FIG. 11 may allow a repair coordinator to assign a technician to a work order. In various embodiments, an option in the display screen of FIG. 11 may allow a repair coordinator to send an electronic invoice for a completed work order. The information shown in FIG. 11 is merely an example. In various embodiments, the display screen may include other information not shown in FIG. 11. In various embodiments, the display screen may not include all of the information shown in FIG. 11. Such and other embodiments are contemplated to be within the scope of the present disclosure.

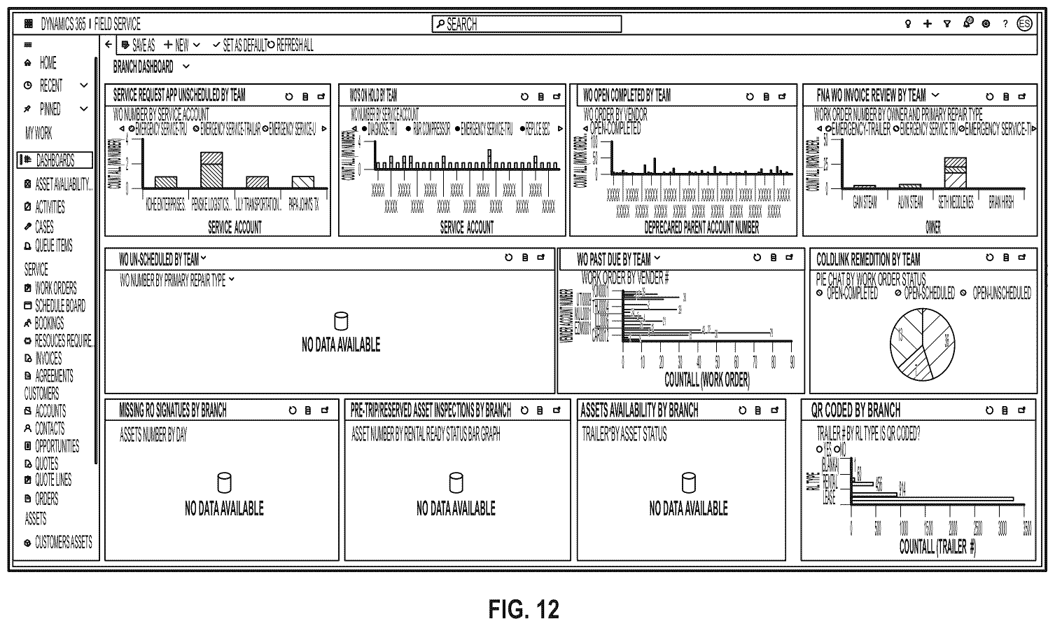

FIG. 12 is an example of a display screen of dashboard for showing various information. The dashboard may contain sub-panels showing various information, including, for example, service requests yet to be scheduled, work orders on hold, work orders that are open and completed, work orders for invoice review, work orders past due, pie chart of work order status, asset inspections by branch, asset availability by branch, and number of QR coded trailers by branch, among other possible information. Each sub-panel may be selected to expand the information in the sub-panel. In various embodiments, the dashboard may be customizable to include or exclude particular sub-panels. The information shown in FIG. 12 is merely an example. In various embodiments, the display screen may include other information not shown in FIG. 12. In various embodiments, the display screen may not include all of the information shown in FIG. 12. Such and other embodiments are contemplated to be within the scope of the present disclosure.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The systems, devices, and/or servers described herein may utilize one or more processors to receive various information and transform the received information to generate an output. The processors may include any type of computing device, computational circuit, or any type of controller or processing circuit capable of executing a series of instructions that are stored in a memory. The processor may include multiple processors and/or multicore central processing units (CPUs) and may include any type of device, such as a microprocessor, graphics processing unit (GPU), digital signal processor, microcontroller, programmable logic device (PLD), field programmable gate array (FPGA), or the like. The processor may also include a memory to store data and/or instructions that, when executed by the one or more processors, causes the one or more processors to perform one or more methods and/or algorithms.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed:

1. A trailer servicing system for facilitating servicing of a trailer fleet, the trailer servicing system comprising:
a central system comprising:
an electronic storage configured to store servicing information relating a plurality of trailers,
at least one processor, and
at least one memory storing instructions; and
a plurality of scannable codes corresponding to the plurality of trailers, each scannable code of the plurality of scannable codes located on or in a respective trailer of the plurality of trailer, wherein each scannable code is configured to, when scanned by a mobile device, enable the mobile device to communicate with the central system regarding servicing for the respective trailer,
wherein the instructions, when executed by the at least one processor of the central system, cause the central system at least to perform:
receiving a plurality of communications, from a plurality of mobile devices, resulting from scanning at least some of the plurality of scannable codes;
for each of the plurality of communications:
accessing, in the electronic storage, servicing information relating to a corresponding trailer, of the plurality of trailers, that corresponds to the respective scannable code that was scanned; and
transmitting, to the respective mobile device, at least a portion of the servicing information relating to the corresponding trailer.

2. The trailer servicing system of claim 1, wherein the plurality of scannable codes comprises QR codes.

3. The trailer servicing system of claim 1, wherein the servicing information relating to the corresponding trailer comprises an identifier of the corresponding trailer.

4. The trailer servicing system of claim 1, wherein the servicing information relating to the corresponding trailer is provided in HTML code relating to the corresponding trailer.

5. The trailer servicing system of claim 4, wherein the HTML code, when executed, causes display of a selectable first user interface element for requesting service for the corresponding trailer.

6. The trailer servicing system of claim 5, wherein the HTML code, when executed, causes display of a selectable second user interface element for a technician relating to servicing work orders.

7. The trailer servicing system of claim 6, wherein the instructions, when executed by the at least one processor of the central system, further cause the central system at least to perform:
based on selection of the first user interface element, transmitting, to the respective mobile device, further HTML code relating to at least one of: creating a service request, or viewing an existing service request; and
based on selection of the second user interface element, transmitting, to the respective mobile device, further HTML code relating to at least one of: requesting authorization for a work order, or reviewing an open work order.

8. A processor-implemented method in a central system for facilitating servicing of a trailer fleet, the method comprising:
receiving a plurality of communications, from a plurality of mobile devices, resulting from scanning at least some of a plurality of scannable codes, the plurality of scannable codes corresponding to a plurality of trailers, wherein each scannable code of the plurality of scannable codes is located on or in a respective trailer of the plurality of trailer, wherein each scannable code is configured to, when scanned by a mobile device, enable the mobile device to communicate with the central system regarding servicing for the respective trailer;
for each of the plurality of communications:
accessing servicing information relating to a corresponding trailer, of the plurality of trailers, that corresponds to the respective scannable code that was scanned; and
transmitting, to the respective mobile device, at least a portion of the servicing information relating to the corresponding trailer.

9. The processor-implemented method of claim 8, wherein the plurality of scannable codes comprises QR codes.

10. The processor-implemented method of claim 8, wherein the servicing information relating to the corresponding trailer comprises an identifier of the corresponding trailer.

11. The processor-implemented method of claim 8, wherein the servicing information relating to the corresponding trailer is provided in HTML code relating to the corresponding trailer.

12. The processor-implemented method of claim 11, wherein the HTML code, when executed, causes display of a selectable first user interface element for requesting service for the corresponding trailer.

13. The processor-implemented method of claim 12, wherein the HTML code, when executed, causes display of a selectable second user interface element for a technician relating to servicing work orders.

14. The processor-implemented method of claim 13, further comprising:
based on selection of the first user interface element, transmitting, to the respective mobile device, further HTML code relating to at least one of: creating a service request, or viewing an existing service request; and
based on selection of the second user interface element, transmitting, to the respective mobile device, further HTML code relating to at least one of: requesting authorization for a work order, or reviewing an open work order.

15. A non-transitory processor-readable medium storing instructions which, when executed by at least one processor of a central system, cause the central system at least to perform:
receiving a plurality of communications, from a plurality of mobile devices, resulting from scanning at least some of a plurality of scannable codes, the plurality of scannable codes corresponding to a plurality of trailers, wherein each scannable code of the plurality of scannable codes is located on or in a respective trailer of the plurality of trailer, wherein each scannable code is configured to, when scanned by a mobile device, enable the mobile device to communicate with the central system regarding servicing for the respective trailer;
for each of the plurality of communications:
accessing servicing information relating to a corresponding trailer, of the plurality of trailers, that corresponds to the respective scannable code that was scanned; and
transmitting, to the respective mobile device, at least a portion of the servicing information relating to the corresponding trailer.

16. The non-transitory processor-readable medium of claim 15, wherein the plurality of scannable code comprises QR codes.

17. The non-transitory processor-readable medium of claim 15, wherein the servicing information relating to the corresponding trailer comprises an identifier of the corresponding trailer.

18. The non-transitory processor-readable medium of claim 15, wherein the servicing information relating to the corresponding trailer is provided in HTML code relating to the corresponding trailer.

19. The non-transitory processor-readable medium of claim 18, wherein the HTML code, when executed, causes display of at least one of the following:
a selectable first user interface element for requesting service for the corresponding trailer, or
a selectable second user interface element for a technician relating to servicing work orders.

20. The non-transitory processor-readable medium of claim 19, further comprising:
based on selection of the first user interface element, transmitting, to the respective mobile device, further HTML code relating to at least one of: creating a service request, or viewing an existing service request; and
based on selection of the second user interface element, transmitting, to the respective mobile device, further HTML code relating to at least one of: requesting authorization for a work order, or reviewing an open work order.
